(19) United States
(12) Patent Application Publication
(10) Pub. No.: US 2023/0342604 A1
(43) Pub. Date: Oct. 26, 2023

(54) DYNAMIC ADDITIVE ATTENTION ADAPTION FOR MEMORY-EFFICIENT MULTI-DOMAIN ON-DEVICE LEARNING

(71) Applicants: Li Yang, Tempe, AZ (US); Deliang Fan, Tempe, AZ (US); Adnan Siraj Rakin, Tempe, AZ (US)

(72) Inventors: Li Yang, Tempe, AZ (US); Deliang Fan, Tempe, AZ (US); Adnan Siraj Rakin, Tempe, AZ (US)

(73) Assignee: Arizona Board of Regents on behalf of Arizona State University, Scottsdale, AZ (US)

(21) Appl. No.: 18/305,097

(22) Filed: Apr. 21, 2023

Related U.S. Application Data
(60) Provisional application No. 63/333,737, filed on Apr. 22, 2022.

(51) Int. Cl. G06N 3/08

(52) U.S. Cl. CPC G06N 3/08

(57) ABSTRACT

Dynamic additive attention adaption for memory-efficient multi-domain on-device learning is provided. Almost all conventional methods for multi-domain learning in deep neural networks (DNNs) only focus on improving accuracy with minimal parameter update, while ignoring high computing and memory cost during training. This makes it difficult to deploy multi-domain learning into resource-limited edge devices, like mobile phones, internet-of-things (IoT) devices, embedded systems, and so on. To reduce training memory usage, while keeping the domain adaption accuracy performance, Dynamic Additive Attention Adaption (DA³) is proposed as a novel memory-efficient on-device multi-domain learning approach. Embodiments of DA³ learn a novel additive attention adaptor module, while freezing the weights of the pre-trained backbone model for each domain. This module not only mitigates activation memory buffering for reducing memory usage during training, but also serves as a dynamic gating mechanism to reduce the computation cost for fast inference.

### CROSS-REFERENCE TO RELATED APPLICATIONS

This application claims priority to U.S. Provisional Application No. 63/333,737, filed on Apr. 22, 2022, incorporated herein by reference in its entirety.

### FIELD OF THE DISCLOSURE

The present disclosure is related to machine learning, and more particularly to multi-domain machine learning.

### BACKGROUND

One practical limitation of current deep neural networks (DNNs) is their high degree of specialization to a single task or domain (e.g., one visual domain). This motivates researchers to develop algorithms that can adapt a DNN model to multiple domains sequentially, while still performing well on past domains. This process of gradually adapting a DNN model to learn from different domain inputs over time is known as multi-domain learning.

The utilization of internet-of-things (IoT) devices has greatly increased (e.g., 250 billion microcontrollers in the world today), which collect massive new data crossing various domains/tasks in daily life. To process the new data, a general approach is to perform learning/training on cloud servers, and then transfer the learned DNN model back to IoT/edge devices for inference only. However, such an approach (i.e., learning-on-cloud and inference-on-device) can be inefficient or unacceptable due to the huge communication cost between cloud and IoT/edge devices, as well as data-privacy concerns (e.g., sensitive health care applications).

### SUMMARY

Dynamic additive attention adaption for memory-efficient multi-domain on-device learning is provided. Almost all conventional methods for multi-domain learning in deep neural networks (DNNs) only focus on improving accuracy with minimal parameter updates, while ignoring high computing and memory costs during training. This makes it difficult to deploy multi-domain learning into resource-limited edge devices, like mobile phones, internet-of-things (IoT) devices, embedded systems, and so on. To reduce training memory usage while keeping the domain adaption accuracy performance, Dynamic Additive Attention Adaption (DA³) is proposed as a novel memory-efficient on-device multi-domain learning approach. Embodiments of DA³ learn a novel additive attention adaptor module, while freezing the weights of the pre-trained backbone model for each domain. This module not only mitigates activation memory buffering for reducing memory usage during training, but also serves as a dynamic gating mechanism to reduce the computation cost for fast inference.

DA³ is validated on multiple datasets against state-of-the-art methods, which shows great improvement in both accuracy and training time. Moreover, an embodiment of DA³ is deployed into the popular NIVDIA Jetson Nano edge graphical processing unit (GPU), where the measured experimental results show the proposed approach of DA³ reduces on-device training memory consumption by 19-37×, and training time by 2×, in comparison to baseline methods (e.g., standard fine-tuning, parallel and series residual adaptors, and piggyback).

An exemplary embodiment provides a method for multi-domain on-device learning. The method includes applying additive adaptation to a machine learning model for a plurality of domains and freezing trained weights of the machine learning model for each of the plurality of domains.

Another exemplary embodiment provides a DNN. The DNN includes a first convolutional layer, a second convolutional layer, and an additive attention adaptor between the first convolutional layer and the second convolutional layer. The additive attention adaptor includes an adaptor configured to adapt an input activation to a given domain and a spatial attention module configured to spatially sample the input activation.

Another exemplary embodiment provides a computing device. The computing device includes a resource-limited processor and a memory. The memory stores instruction which, when executed, cause the resource-limited processor to deploy a DNN model and adapt the DNN model to learn in multiple domains on the resource-limited processor.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a graphical representation of memory usage and training time for adapting a DNN under various approaches.

FIG. 2 is a schematic diagram of an additive attention adaptor according to embodiments described herein.

FIG. 3 is a graphical representation of the trade-off between test accuracy and training time for four datasets.

FIG. 4 is a flow diagram illustrating a process for multi-domain on-device learning.

FIG. 5 is a block diagram of an edge computing device suitable for implementing the additive attention adaptor according to embodiments disclosed herein.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Dynamic additive attention adaption for memory-efficient multi-domain on-device learning is provided. Almost all conventional methods for multi-domain learning in deep neural networks (DNNs) only focus on improving accuracy with minimal parameter updates, while ignoring high computing and memory costs during training. This makes it difficult to deploy multi-domain learning into resource-limited edge devices, like mobile phones, internet-of-things (IoT) devices, embedded systems, and so on. To reduce training memory usage, while keeping the domain adaption accuracy performance, Dynamic Additive Attention Adaption (DA³) is proposed as a novel memory-efficient on-device multi-domain learning approach. Embodiments of DA³ learn a novel additive attention adaptor module, while freezing the weights of the pre-trained backbone model for each domain. This module not only mitigates activation memory buffering for reducing memory usage during training, but also serves as a dynamic gating mechanism to reduce the computation cost for fast inference.

DA³ is validated on multiple datasets against state-of-the-art methods, which shows great improvement in both accuracy and training time. Moreover, an embodiment of DA³ is deployed into the popular NIVDIA Jetson Nano edge graphical processing unit (GPU), where the measured experimental results show the proposed approach of DA³ reduces on-device training memory consumption by 19-37×, and training time by 2×, in comparison to baseline methods (e.g., standard fine-tuning, parallel and series residual adaptors, and piggyback).

### INTRODUCTION

Conventional multi-domain learning methods for deep neural networks (DNNs) can be mainly divided into three types: fine-tuning based method, adaptor-based method, and mask-based method. The first approach, fine tuning, is inspired by the success of transfer learning, and is a natural approach to optimize the whole pre-trained model from old domains to new target domains. However, the training cost is huge since all parameters need to be updated, and the overall size of parameters will increase linearly with the number of domains. One alternative method is to only fine-tune the batch-norm and last classifier, but this suffers from limited domain adaption capacity.

Under the second approach, an adaptor-based method has been proposed which learns a domain-specific residual adaptor while freezing the pre-trained model. This method needs to fine-tune the batch-norm layer of the pre-trained model to avoid domain shift. In one example of the third approach, a mask-based learning method proposes to only learn a binary elementwise mask ({0,1}) with respect to all weights, while keeping the pre-trained model fixed.

The present disclosure finds that, although adaptor- and mask-based methods reduce the training cost by freezing the pre-trained model compared with the fine-tuning based method, the ways of learning domain-specific parameters are inefficient in terms of activation memory. This memory inefficiency is found herein to be a significant bottleneck for on-device multi-domain learning.

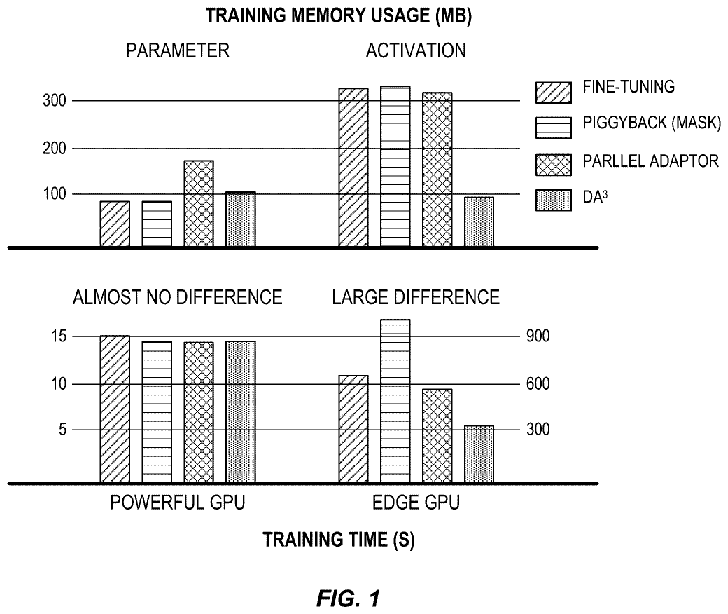

FIG. 1 is a graphical representation of memory usage and training time for adapting a DNN under various approaches. To investigate the possibility of on-device learning for multi-domain learning methods, the three representative methods were tested for adapting ResNet50 to the Flower dataset and compared with the approach described herein (DA³). The top graph shows model parameters and activation memory of fine-tuning, piggyback (e.g., a mask-based method), a parallel adaptor, and DA³. The bottom shows training time of these same approaches on two different platforms: a powerful GPU (Nvidia RTX5000 used in desktop or cloud server training) and edge GPU (Nvidia Jetson Nano GPU used in edge device training).

It was observed that the training process is memory-intensive, where the intermediate activation buffering in memory during back-propagation is the bottleneck (at least 3×more than the model itself) to limit the speed of on-edge-device learning.

During training, the memory usage for activation storage (referred to as activation memory herein) is almost 3×larger than the model itself. Such large training memory is not an issue (assuming the same training time) in a powerful GPU with large enough memory capacity. However, for the memory-limited edge GPUs typically used in edge device training, such large memory usage becomes the bottleneck to limit training speed, and correspondingly leads to significantly different training speeds across different training methods for the same network and dataset as shown in FIG. 1. Almost all prior domain adaption schemes only emphasize improving accuracy with minimal parameter updates, while ignoring the computing- and memory-intensive nature of their methods, which makes them inefficient to deploy into resource-limited edge-based training devices, like mobile phones, embedded systems, IoT devices, etc.

The present disclosure proposes DA³ as a new training scheme for memory-efficient on-device multi-domain learning (referred to herein simply as on-device learning). Differentiating from prior works, the DA³ approach is designed to eliminate the storage of intermediate activation feature map(s) (i.e., dominating memory usage during on-device learning) to greatly reduce overall memory usage. Furthermore, to improve the adaption accuracy performance, DA³ is embedded with a novel dynamic additive attention adaptor module, which is not only designed to avoid activation buffering for memory saving during training, but also reduces the computation cost through a dynamic gating mechanism.

In summary, the technical contributions of the present disclosure include:

First, a complete analysis of memory consumption during training is presented to prove that activation memory buffering is the key memory bottleneck during on-device multi-domain learning. More importantly, based on this analysis, an important observation guided the design of DA³: the complete activation map (i.e., dominating memory usage) needs to be stored for backward propagation during training if it has a multiplicative relationship with learned parameters (i.e., weight, mask), while the additive relationship (i.e., bias) is activation free.

Following the memory usage analysis, a novel training method, referred to as DA³, is presented for memory-efficient on-device multi-domain learning. The main idea of DA³ is that it freezes the learned parameters which have a multiplicative relationship with input activation, and only updates the learnable parameters that have an additive relationship. Thus, there is no need to store the memory-dominating activation feature map during backward propagation. Moreover, to further enrich the adaption capacity, a novel additive attention adaptor module is proposed that not only follows the additive principle to eliminate dominating activation memory buffering, but also implements a dynamic gating mechanism to reduce inference computation complexity. Such adaptor can be seamlessly integrated into popular backbone model architectures for memory-efficient multi-domain learning.

Extensive evaluation is made of the proposed DA³ method compared with prior competitive baselines. DA³ achieves state-of-the-art accuracy on popular multi-domain adaption datasets. More importantly, unlike previous methods, the training efficiency is tested on an edge GPU (i.e., NVIDIA Jetson Nano) to prove that DA³ greatly reduces the training cost (i.e., both memory and time) in real devices. The evaluation results show that DA³ reduces on-device training memory consumption by 19-37× and actual training time by 2× in comparison to the baseline methods (e.g., standard fine-tuning, parallel and series residual adaptor, and piggyback).

### Memory Analysis in Multi-Domain Training

This section first explores the training memory usage under different multi-domain learning methods. Then, a quantitative analysis of memory usage is conducted for each layer of a DNN model. Moreover, such analysis guides the solution presented herein to achieve on-device memory-efficient learning.

Both fine-tuning and adaptor-based training schemes are popular in this research area, which requires fine-tuning all or a subset of parameters in the pre-trained model. A fine-tuning training method on a target dataset domain is intuitive to understand. But, to explain the adaptor-based method, the architectures of two popular adaptor-based methods are illustrated. Such methods need to fine-tune the additional convolution layer and the original batch-norm (BN) layers. To understand the training memory consumption, assume a linear layer whose forward process be modeled as: aᵢ₊₁=aᵢW+b, then its back-propagation process is

$$\frac{\partial ℒ}{\partial {a}_{i}} = \frac{\partial ℒ}{\partial {a}_{i + 1}} \frac{\partial {a}_{i + 1}}{\partial {a}_{i}} = \frac{\partial ℒ}{\partial {a}_{i}} {W}^{T} \frac{\partial ℒ}{\partial W} = {a}_{i} \frac{\partial ℒ}{\partial {a}_{i + 1}} \frac{\partial ℒ}{\partial b} = \frac{\partial ℒ}{\partial {a}_{i + 1}} \qquad Equation 1$$

According to Equation 1, to conduct conventional back-propagation based training for the entire model, model weights (W), gradients and activation (aᵢ) all need to be stored for computing, leading to high memory usage. However, it is interesting to see that, if only updating bias, which has an additive relationship with activation (aᵢ), no activation storage is needed since previous activation aᵢ is not involved in the backward computation. The same phenomena can also be found in both convolutional and BN layers.

For the mask-based learning method, assuming a linear layer whose forward process is given as: aᵢ+1=aᵢ(W·M)+b, where M is the mask to be learned with the same size as W. The weights (W) are fixed, while only training the mask (M). Then the backward process can be shown as:

$$\frac{\partial ℒ}{\partial M} = {a}_{i} \frac{\partial ℒ}{\partial {a}_{i + 1}} W \frac{\partial ℒ}{\partial b} = \frac{\partial ℒ}{\partial {a}_{i + 1}} \qquad Equation 2$$

Equation 2 shows that learning mask needs to store not only activation aᵢ, but also the mask M and weights W during training. In terms of computation, comparing Equation 2 with Equation 1, such methods also need additional multiplication computation in both forward and backward passes. These observations explain why piggyback has the largest training time in edge GPUs as shown in FIG. 1. Other mask-based methods have even higher computation costs than piggyback because they involve additional reparameterization techniques. In addition, similar to fine-tuning and adaptor-based methods, training bias does not involve activation storage.

Here, training memory usage is defined as will be used in the rest of this disclosure. As displayed in Table 1, memory usage is proportional to the number of parameters during training, which can be treated as two main groups: i) number of trainable parameters—p (i.e., weights, bias) and gradient of each parameter; ii) activation memory consisting of the feature maps stored to update the parameters of previous layers using the chain rule. Note, trainable parameter memory has the same size as gradient memory. Only the number of trainable parameters—p are listed in Table 1.

TABLE 1
Summary of the parameters and activation
memory consumption of different layers

| Layer Type | Trainable Parameter (p) | Activation (a) |
|---|---|---|
| Conv | cᵢₙ × cₒᵤₜ × kh × kw | n × cᵢₙ × h × w |
| FC | cᵢₙ × cₒᵤₜ + cₒᵤₜ | n × cᵢₙ × h × w |
| BN | 2 × cₒᵤₜ | n × cᵢₙ × h × w |
| ReLU | 0 | n × cᵢₙ × h × w |
| Sigmoid | 0 | n × cᵢₙ × h × w |

The weights are denoted W^{(l)}∈ [symbol] ^{c}^{ᵢₙ}^{×c}^{ₒᵤₜ}^{×kh×kw}, where cᵢₙ, cₒᵤₜ, kh, kw refer to the weight dimension of the l-th layer, including number of output channels, number of input channels, kernel height and width, respectively. Also, the input activation is denoted A^{(l)}∈ [symbol] ^{n×c}^{ᵢₙ}^{×h×w}, where n, h, w refer to the batch size, activation height and width, respectively.

For most convolution layers, kernel height/width is much smaller than activation channel width/height (i.e., kh<<h; kw<<w). Thus, for a moderate batch size (e.g., n=64/128/256), activation memory size is much larger than that of the trainable parameters (i.e., a>>p). More interestingly, even though BN and sigmoid function have a negligible number of trainable parameters (p), both functions produce an activation output (a) of the same size as a CONV/FC layer.

From the above analysis, it can be easily seen that DNN training memory usage is dominated by the activation feature map storage rather than the model parameter itself. It is important to optimize the activation feature map memory usage if targeting memory-efficient learning. As for existing multi-domain learning methods, both mask-based and fine-tuning methods require heavy memory consumption during the backward propagation, requiring storage for all weights, gradients, and activation. Moreover, extra mask memory is required for the mask-based method. It is also interesting to observe that, if it is possible to only update bias in multi-domain learning, the dominating memory usage component (activation) is not required anymore. This is because bias has an additive-only relationship with input activation, enabling backward propagation independently. Based on the above analysis, the underlying reason is summarized as below, which motivates and justifies the DA³ method disclosed in the next section.

Another observation as disclosed herein is that the complete activation map needs to be stored for backward propagation during training if it has a multiplicative relationship with a learned parameter (i.e., weight, mask), while an additive relationship (e.g., bias) is activation-free.

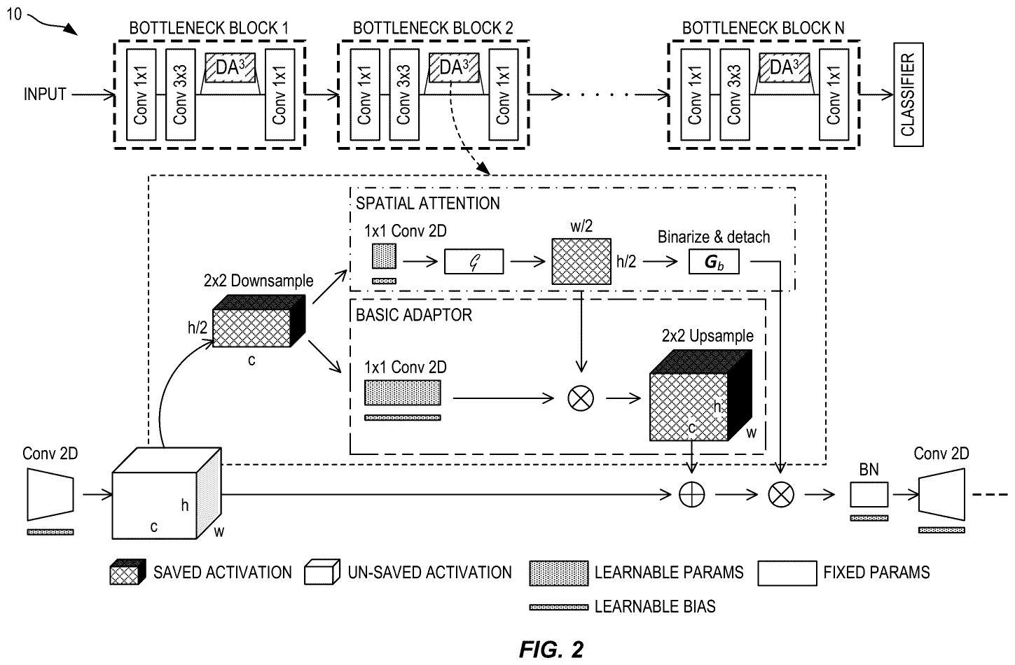

FIG. 2 is a schematic diagram of an additive attention adaptor 10 according to embodiments described herein. Motivated by the above memory usage analysis, a new training approach is proposed and named Dynamic Additive Attention Adaption (DA³). DA³ introduces a novel additive attention adaptor module in each block for a given DNN model, that follows an additive relationship with the weight of the main branch (i.e., pre-trained model) as mentioned in Observation 2. To learn each new domain, DA³ only updates the additive attention adaptor and the bias of the pre-trained model, while freezing the corresponding weight to preserve the knowledge of the previous domains.

As the detailed structure of the additive attention adaptor illustrates in FIG. 2, it aims to refine the activation of the pretrained model, which is computed as:

A*ᵢ=A+H(A)) Equation 3

where H denotes the output activation of the additive attention adaptor module.

To design an efficient yet powerful module, the spatial attention Hₛ and the basic adaptor Hₐ are first computed at two parallel branches, then combined as:

H(A)= [symbol] (Hₛ(A))⊗Hₐ(A) Equation 4

where ⊗ denotes the element-wise multiplication and [symbol] (·) is a Gumbel-Softmax function to obtain the spatial-wise soft attention of the basic adaptor activation Hₐ. In other embodiments, a Softmax function may be used in place of the Gumbel-Softmax.

Furthermore, instead of fully utilizing the pre-trained model as in prior works, the important weights for the current domain are selected by turning the soft attention [symbol] (Hₛ (A)) into binary hard gating G_{b}∈{0,1}. Then, Equation 3 can be further modified as:

A*ᵢ=(A+H(A))⊗G_{b}^{detach} Equation 5

Importantly, as the gating G_{b} has a multiplicative relationship with the activation of the pre-trained model A, the gating G_{b} is detached from backward computation graph. By doing so, the detached G_{b}^{detach} is only used for forward pass that has no gradient to do backward propagation during training. Thus, it will not cause additional activation memory storage from the main branch pre-trained model.

As shown in Equation 1, the activation size grows quadratically with the resolution (i.e., height and width). Thus, to reduce the activation size, in the basic adaptor branch, a 2×2 average pooling is used to down-sample the input feature map, followed by a 1×1 convolution layer.

To sample the activation in spatial-wise (i.e., n×1×h/2×w/2) after down-sampling, a 1×1 convolution layer is adopted with the output channel as 1. Then, following the Gumbel-softmax function [symbol] (·), the soft attention is obtained. Such soft attention plays two roles: 1) it is multiplied with the basic adaptor output to strengthen the domain-refined activation; 2) it turns to binary hard gating G_{b}∈{0,1} by applying a binarization trick and then multiplying with the output of main branch activation. By doing so, it could dynamically select the input-relevant spatial position for the current domain. To avoid activation storage of the main branch during training, the binary gating is detached from the computation graph that has no gradient to do backward propagation. In some embodiments, the binarization function is a thresholding function, where the threshold may be, for example, 0.5. It is understood that in various embodiments, different values of threshold may be used in order to influence the binarization output, for example 0.3, 0.35, 0.4, 0.45, 0.55, 0.6, 0.65, 0.7, or any other suitable value.

Following the spatial attention branch and basic adaptor branch, the up-sampled and domain-refined activation is added to the main branch (pre-trained backbone model) output activation. Note that, different from the conventional attention scheme, where the output directly multiplies the main branch output activation, the additive attention adaptor is designed in a way to add it to the main branch. The main benefit of doing so is the proposed additive attention adaptor module can be processed during backward independently, without creating a new backward pass as in the traditional multiplication-based mechanism. Therefore, the increased memory usage for the proposed additive attention adaptor is very limited, as discussed further below.

FIG. 2 further illustrates an example of integrating the proposed additive attention adaptor in a bottleneck block on ResNet. For the basic block which has two connected convolution layers, the additive attention adaptor is plugged in after the last convolution layer. For the bottleneck block, the last convolution layer will enlarge the output channels (i.e., 4×), which increases the output activation linearly. To avoid involving large activation increases, the additive attention adaptor is added after the second convolution layer.

### Evaluation

To evaluate the efficacy of the proposed DA³ method, standard and popular multi-domain learning datasets are used similar to many prior works. This setting includes five datasets (e.g., WikiArt (Saleh and Elgammal 2015), Sketch (Eitz, Hays, and Alexa 2012), Stanford Cars (Krause et al. 2013), CUBS (Wah et al. 2011), and Flowers (Nilsback and Zisserman 2008)). For each dataset, the test accuracy (%) on the publicly available test set is reported.

Additionally, the proposed method is evaluated on the Visual Decathlon Challenge (Rebuffi, Bilen, and Vedaldi 2018). The challenge is designed to evaluate the performance of learning algorithms on images from ten visual domains. The score (S) is evaluated as: S=Σᵢ₌₁¹⁰aᵢ{0, Eᵢₘₐₓ−Eᵢ}², where Eᵢ is the best error on domain Eᵢ, Eᵢₘₐₓ is the error of a reasonable baseline method, and the co-efficient aᵢ is 1000(Eᵢ^{max})⁻².

Finally, to evaluate the training efficiency of DA³, the algorithm is run in the NVIDIA Jetson Nano GPU, which has 4 GB DRAM with 20 W power supply. The training time on this edge GPU (i.e., having constrained memory) is evaluated to demonstrate the memory-efficient training through DA³.

This disclosure primarily compares the proposed method with three different baseline methods:

Fine-tuning-based method: Two fine-tuning strategies are considered. The first baseline fine-tunes all the parameters of the pre-trained model on each new dataset (Yosinski et al. 2014). Alternatively, the second one only fine-tunes the batch-norm and last classifier layers.

Adaptor-based method: This baseline learns a residual adaptor for each convolution layer, while freezing the pre-trained weights except in the batch-norm layer. A comparison is made with three different residual adaptor designs: series adaptor (Rebuffi, Bilen, and Vedaldi 2017), parallel adaptor (Rebuffi, Bilen, and Vedaldi 2018) and TinyTL (Cai et al. 2020). Note that TinyTL is reproduced by applying the lite residual adaptor without network architecture search.

Mask-based method: Piggyback (Mallya, Davis, and Lazebnik 2018) is chosen as a popular binary mask learning scheme that keeps the underlying pre-trained weights fixed. It only trains the binary mask to learn a large number of filters on top of a fixed set of pre-trained weights.

The algorithm's efficacy is first compared with baseline methods by evaluating the performance on the test dataset listed in Table 2. Next, the efficiency in reducing the training cost is evaluated after deploying the models in NVIDIA Jetson Nano GPU in Table 3.

In this evaluation section, each baseline method and DA³ train a ResNet-50 model with pre-trained weights on the ImageNet dataset. As shown in Table 2, the proposed method DA³ achieves the best test accuracy in CUBS, Stanford Cars and Flowers dataset. As for WikiArt, standard fine-tuning outperforms all the other techniques. Since WikiArt has the smallest number of samples between training and testing datasets in comparison to the other datasets, it helps to mitigate the over-fitting issue of fine-tuning the entire model. Finally, most notably, DA³ achieves comparable accuracy in comparison to the best baseline technique Parallel Res. Adaptor (Rebuffi, Bilen, and Vedaldi 2018), achieving fractionally improved test accuracy in CUBS, Stanford Cars, and Flowers dataset, but much smaller training time shown in later Table 3. In summary, the proposed DA³ method achieves improved or comparable test accuracy in comparison to all the baseline techniques on five evaluation datasets.

TABLE 2
Summary of the results of the proposed method and comparison
with the baseline techniques on five datasets

| Model | CUBS | Stanford Cars | Flowers | WikiArt | Sketches | Average |
|---|---|---|---|---|---|---|
| Standard Fine-tuning | 81.86 | 89.74 | 93.67 | 75.60 | 79.58 | 84.09 |
| BN Fine-tuning | 80.12 | 87.54 | 91.32 | 70.31 | 78.45 | 81.54 |
| Parallel Res. adapt | 82.54 | 91.21 | 96.03 | 73.68 | 82.22 | 85.14 |
| Series Res. adapt | 81.45 | 89.65 | 95.77 | 72.12 | 80.48 | 83.89 |
| Piggyback | 81.59 | 89.62 | 94.77 | 71.33 | 79.91 | 83.45 |
| TinyTL | 82.34 | 90.23 | 94.63 | 71.39 | 80.44 | 83.80 |
| DA³ | 83.33 | 91.50 | 96.65 | 72.79 | 82.20 | 85.29 |

Table 3 summarizes key contributions of the proposed approach in reducing the training and inference cost of multi-domain learning. Note that those are evaluated in a real memory-limited NVIDIA Jetson Nano GPU. As shown in Table 3, the disclosed DA³ method increases the model size by only a small fraction in comparison to Standard/BN Fine-tuning (Mudrakarta et al. 2018) and Piggyback (Mallya, Davis, and Lazebnik 2018) methods. However, DA³ reduces the activation memory size by 19-37× in comparison to the baseline techniques. As stated before, Parallel Res. Adaptor (Rebuffi, Bilen, and Vedaldi 2018) has shown superior performance (i.e., higher test accuracy) across four datasets. But DA³ is shown to reduce the activation memory size by 34× when compared with Parallel Res. Adaptor's activation memory size while maintaining a similar test accuracy.

TABLE 3
Summary of the results of the proposed method and comparison with
the baseline techniques on four datasets on NVIDIA Jetson Nano GPU

| Dataset | | | | | | | |
|---|---|---|---|---|---|---|---|
| | Model | Activ | | | | | |
| | Param | Mem | Inference | Flowers | CUBS | Cars | Sketches |
| Methods | (MB) | (MB) | GFlops | Training Time (s) | | | |
| Standard Fine-tuning | 91.27 | 343.76 | 4.15 | 686 | 1977 | 2676 | 5843 |
| BN Fine-tuning | 91.27 | 174.17 | 4.15 | 173 | 507 | 683 | 1300 |
| Parallel Res. adapt | 177.8 | 308.8 | 4.68 | 558 | 1741 | 1604 | 4669 |
| Series Res. adapt | 178 | 309.55 | 4.68 | 570 | 1832 | 1690 | 4783 |
| Piggyback | 94.12 | 343.76 | 3.44 | 1061 | 3015 | 4327 | 9783 |
| DA³ | 98.64 | 10.49 | 3.17 | 308 | 834 | 1073 | 2274 |

Apart from the reduction in memory cost, the disclosed DA³ method speeds up the actual training time for on-device learning as well. As shown in Table 3, the training time is reduced nearly by 2× in comparison to all the baseline techniques except for BN Fine-tuning (Mudrakarta et al. 2018). The faster training of BN Fine-tuning can be attributed to the presence of significantly fewer learnable parameters (less than 1 MB), resulting in the worst accuracy performance in Table 2. Nevertheless, the proposed method still outperforms BN based Fine-tuning in both reducing activation memory size (i.e., 19×) and improved test accuracy across four datasets (e.g., CUBS, Stanford Cars, Flowers and Sketches).

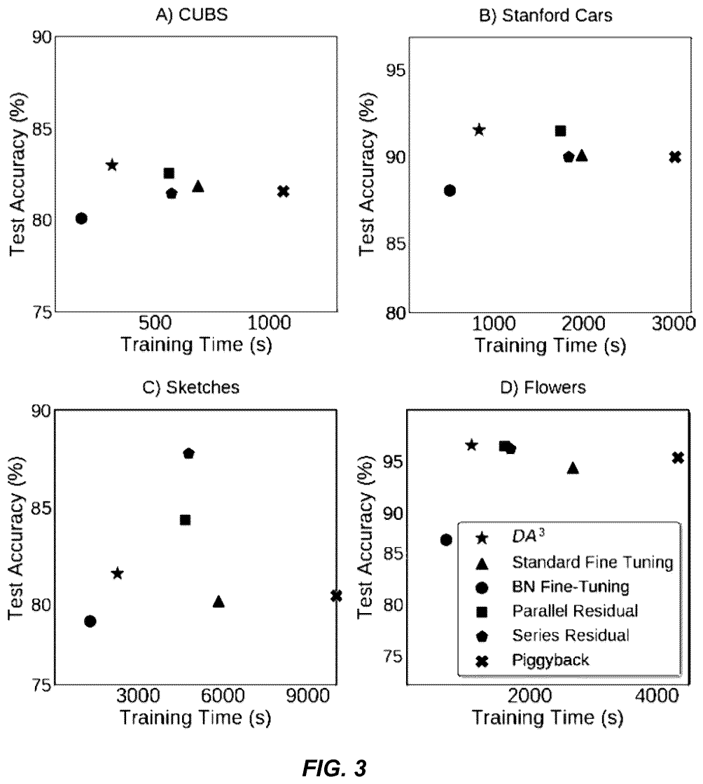

FIG. 3 is a graphical representation of the trade-off between test accuracy and training time for four datasets. To summarize, FIG. 3 shows that DA³ reduces training cost (i.e., time) in comparison to all baseline methods (except BN fine-tuning); while maintaining on-par or improved test accuracy compared with the best (i.e., highest test accuracy %) baseline method (i.e., Parallel Residual (Rebuffi, Bilen, and Vedaldi 2018)).

Moreover, the averaged inference computation cost on the five datasets is summarized in FIG. 3. Benefitting from the spatial adaptor design, DA³ further achieves 1.30×, 1.47× and 1.08× inference computation cost reduction compared with fine-tuning-based, adaptor-based and mask-based methods, respectively.

Table 4A and Table 4B below show the effectiveness of the proposed learning scheme on all the ten datasets of Visual Decathlon Challenge on ResNet-26. Note that, for this experiment, an additive attention adaptor is plugged to each convolution layer. As reported in Table 4A and Table 4B, DA³ achieves ˜3% accuracy gain on ImageNet and ˜4% accuracy gain on Flower in comparison to the baseline methods. Moreover, it achieves the best S score (3498) out of all the previous techniques demonstrating the effectiveness of the proposed method in adapting to multi-domain tasks. Finally, DA³ can also reduce the activation memory storage overhead during training by 7-11× in comparison to other methods, thus emerging as an ideal candidate for on-device learning purposes.

TABLE 4A
Summary of the results on the Visual Decathlon Challenge dataset

| | Model | Activ | | | | | |
|---|---|---|---|---|---|---|---|
| | Mem | Mem | | | | | |
| Methods | (MB) | (MB) | Imnet | Airc. | C100 | Dped | DTD |
| Scratch | 22.29 | 1315 | 59.87 | 57.1 | 75.73 | 91.2 | 37.77 |
| Fine-tuning | 22.29 | 1315 | 60.32 | 61.87 | 82.12 | 92.82 | 55.53 |
| Series Res. | 24.94 | 1963 | 60.32 | 61.87 | 81.22 | 93.88 | 57.13 |
| adapt | | | | | | | |
| Parallel Res. | 23.62 | 1405 | 60.32 | 64.21 | 81.92 | 94.73 | 58.83 |
| adapt | | | | | | | |
| Piggyback | 22.29 | 1315 | 57.69 | 65.29 | 79.87 | 96.99 | 57.45 |
| DA³ | 25.36 | 201.7 | 62.74 | 64.58 | 82.82 | 96.85 | 59.43 |

TABLE 4B
Summary of the results on the Visual Decathlon Challenge dataset

| Methods | GTSR | Flwr | Oglt | SVHN | UCF | Score |
|---|---|---|---|---|---|---|
| Scratch | 96.55 | 56.30 | 88.74 | 96.63 | 43.27 | 1625 |
| Fine-tuning | 99.42 | 81.41 | 89.12 | 96.55 | 51.2 | 3096 |
| Series Res. adapt | 99.27 | 81.67 | 89.62 | 96.57 | 50.12 | 3159 |
| Parallel Res. adapt | 99.38 | 84.68 | 89.21 | 96.54 | 50.94 | 3412 |
| Piggyback | 97.27 | 79.09 | 87.63 | 97.24 | 47.48 | 2838 |
| DA³ | 99.44 | 88.62 | 89.73 | 97.47 | 51.29 | 3498 |

The effectiveness of each component in the proposed additive attention adaptor on ImageNet-to-Sketch dataset setting is studied. As shown in Table 5, four different combinations are considered to perform this ablation study: 1) Only updating bias (Only bias); 2) Only updating the basic adaptor module (Only Basic adap.); 3) Jointly updating the bias and spatial adaptor (Bias+Basic adap); 4) Jointly updating the proposed additive attention adaptor with bias. First, only bias has the worst accuracy, demonstrating the limited learning capacity using only a few bias parameters, supporting the initial hypothesis of adding the attention adaptor to improve learning capacity. As a result, after adding the spatial adaptor, a clear accuracy gain is observed. Furthermore, jointly updating bias and spatial adaptor could improve accuracy even further. In the end, the proposed DA³ is introduced utilizing the channel attention module which connects the spatial adaptor in parallel to achieve the best performance. As DA³ succeeds in maintaining a reasonable test accuracy while drastically reducing the training overhead (as shown in Table 3 and FIG. 3).

TABLE 5
The ablation study on the proposed method

| Method | CUBS | Cars | Flowers | WikiArt | Sketch |
|---|---|---|---|---|---|
| Only bias | 74.53 | 83.85 | 87.30 | 68.73 | 71.93 |
| Only basic adap. | 82.01 | 89.03 | 95.03 | 71.33 | 80.42 |
| Bias + basic adap. | 82.15 | 89.73 | 95.56 | 71.88 | 80.70 |
| DA³ | 83.33 | 91.50 | 96.65 | 72.79 | 82.20 |

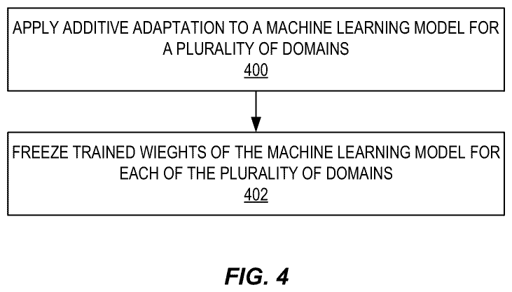

FIG. 4 is a flow diagram illustrating a process for multi-domain on-device learning. The process begins at operation 400, with applying additive adaptation to a machine learning model for a plurality of domains. The process continues at operation 402, with freezing trained weights of the machine learning model for each of the plurality of domains.

Although the operations of FIG. 4 are illustrated in a series, this is for illustrative purposes and the operations are not necessarily order dependent. Some operations may be performed in a different order than that presented. Further, processes within the scope of this disclosure may include fewer or more steps than those illustrated in FIG. 4.

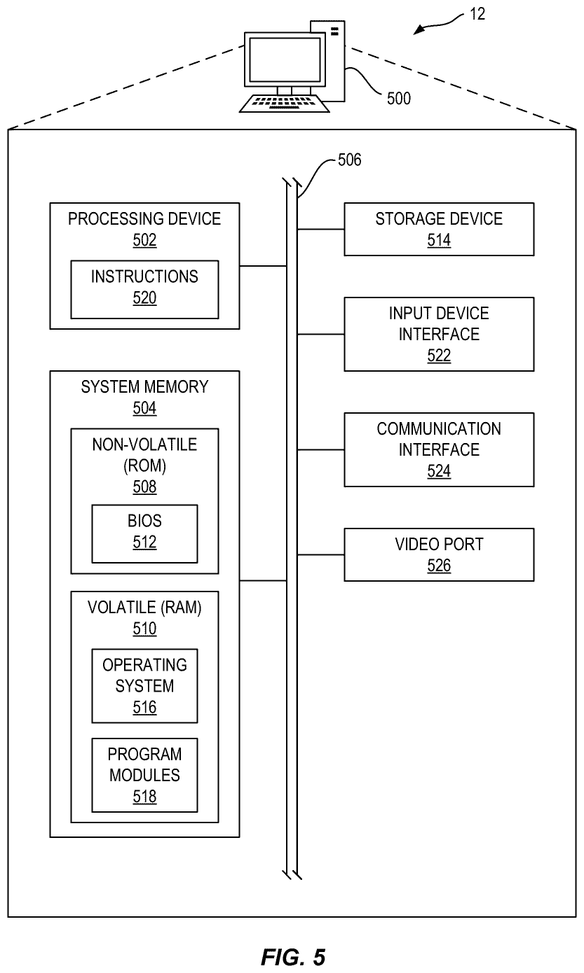

FIG. 5 is a block diagram of an edge computing device 12 suitable for implementing the additive attention adaptor 10 according to embodiments disclosed herein. The edge computing device 10 includes or is implemented as a computer system 500, which comprises any computing or electronic device capable of including firmware, hardware, and/or executing software instructions that could be used to perform any of the methods or functions described above, such as multi-domain on-device learning. In this regard, the computer system 500 may be a circuit or circuits included in an electronic board card, such as a printed circuit board (PCB), a server, a personal computer, a desktop computer, a laptop computer, an array of computers, a personal digital assistant (PDA), a computing pad, a mobile device, or any other device, and may represent, for example, a server or a user's computer.

The exemplary computer system 500 in this embodiment includes a processing device 502 or processor, a system memory 504, and a system bus 506. The processing device 502 represents one or more commercially available or proprietary general-purpose processing devices, such as a microprocessor, central processing unit (CPU), or the like. More particularly, the processing device 502 may be a complex instruction set computing (CISC) microprocessor, a reduced instruction set computing (RISC) microprocessor, a very long instruction word (VLIW) microprocessor, a processor implementing other instruction sets, or other processors implementing a combination of instruction sets. The processing device 502 is configured to execute processing logic instructions for performing the operations and steps discussed herein.

In this regard, the various illustrative logical blocks, modules, and circuits described in connection with the embodiments disclosed herein may be implemented or performed with the processing device 502, which may be a microprocessor, field programmable gate array (FPGA), a digital signal processor (DSP), an application-specific integrated circuit (ASIC), or other programmable logic device, a discrete gate or transistor logic, discrete hardware components, or any combination thereof designed to perform the functions described herein. Furthermore, the processing device 502 may be a microprocessor, or may be any conventional processor, controller, microcontroller, or state machine. The processing device 502 may also be implemented as a combination of computing devices (e.g., a combination of a DSP and a microprocessor, a plurality of microprocessors, one or more microprocessors in conjunction with a DSP core, or any other such configuration).

The system memory 504 may include non-volatile memory 508 and volatile memory 510. The non-volatile memory 508 may include read-only memory (ROM), erasable programmable read-only memory (EPROM), electrically erasable programmable read-only memory (EEPROM), and the like. The volatile memory 510 generally includes random-access memory (RAM) (e.g., dynamic random-access memory (DRAM), such as synchronous DRAM (SDRAM)). A basic input/output system (BIOS) 512 may be stored in the non-volatile memory 508 and can include the basic routines that help to transfer information between elements within the computer system 500.

The system bus 506 provides an interface for system components including, but not limited to, the system memory 504 and the processing device 502. The system bus 506 may be any of several types of bus structures that may further interconnect to a memory bus (with or without a memory controller), a peripheral bus, and/or a local bus using any of a variety of commercially available bus architectures.

The computer system 500 may further include or be coupled to a non-transitory computer-readable storage medium, such as a storage device 514, which may represent an internal or external hard disk drive (HDD), flash memory, or the like. The storage device 514 and other drives associated with computer-readable media and computer-usable media may provide non-volatile storage of data, data structures, computer-executable instructions, and the like. Although the description of computer-readable media above refers to an HDD, it should be appreciated that other types of media that are readable by a computer, such as optical disks, magnetic cassettes, flash memory cards, cartridges, and the like, may also be used in the operating environment, and, further, that any such media may contain computer-executable instructions for performing novel methods of the disclosed embodiments.

An operating system 516 and any number of program modules 518 or other applications can be stored in the volatile memory 510, wherein the program modules 518 represent a wide array of computer-executable instructions corresponding to programs, applications, functions, and the like that may implement the functionality described herein in whole or in part, such as through instructions 520 on the processing device 502. The program modules 518 may also reside on the storage mechanism provided by the storage device 514. As such, all or a portion of the functionality described herein may be implemented as a computer program product stored on a transitory or non-transitory computer-usable or computer-readable storage medium, such as the storage device 514, volatile memory 510, non-volatile memory 508, instructions 520, and the like. The computer program product includes complex programming instructions, such as complex computer-readable program code, to cause the processing device 502 to carry out the steps necessary to implement the functions described herein.

An operator, such as the user, may also be able to enter one or more configuration commands to the computer system 500 through a keyboard, a pointing device such as a mouse, or a touch-sensitive surface, such as the display device, via an input device interface 522 or remotely through a web interface, terminal program, or the like via a communication interface 524. The communication interface 524 may be wired or wireless and facilitate communications with any number of devices via a communications network in a direct or indirect fashion. An output device, such as a display device, can be coupled to the system bus 506 and driven by a video port 526. Additional inputs and outputs to the computer system 500 may be provided through the system bus 506 as appropriate to implement embodiments described herein.

The operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined.

Those skilled in the art will recognize improvements and modifications to the preferred embodiments of the present disclosure. All such improvements and modifications are considered within the scope of the concepts disclosed herein and the claims that follow.

What is claimed is:

1. A method for multi-domain on-device learning, comprising:
providing a machine learning model having an input layer, a plurality of hidden layers, and an output layer;
down-sampling an input feature map of a first layer of the plurality of hidden layers to provide a basic adaptor input;
calculating a soft attention from the down-sampled input feature map;
binarizing the soft attention to obtain a set of binary weighting values selected from 0 and 1;
multiplying the basic adaptor input by the soft attention to provide a weighted basic adaptor input;
up-sampling the weighted basic adaptor input to provide a basic adaptor output;
adding the basic adaptor output to the input feature map to provide an adapted feature map;
multiplying the adapted feature map by the set of binary weighting values; and
providing the multiplied adapted feature map to a subsequent layer of the machine learning model.

2. The method of claim 1, wherein the down-sampling step comprises 2×2 average pooling

3. The method of claim 1, wherein the soft attention is calculated using a Gumbel-softmax function.

4. The method of claim 1, wherein the binarization comprises a thresholding function.

5. The method of claim 1, wherein the method further comprises the step of freezing learned parameters of the machine learning model which have a multiplicative relationship with input activation.

6. A dynamic additive attention module for a deep neural network, comprising:
an adaptor configured to accept an input activation and provide an output activation, the adaptor comprising a spatial attention module and a basic adaptor module;
the spatial attention module configured to accept a down-sampled copy of the input activation and to calculate a soft attention value and a binarized soft attention value;
the basic adaptor module configured to accept the down-sampled copy of the input activation and the soft attention value, and calculate an up-sampled, weighted input activation;
a spatial attention module configured to spatially sample the input activation.

7. The dynamic additive attention module of claim 6, further comprising a 2×2 down-sampler configured to convert the input activation to the down-sampled copy of the input activation.

8. The dynamic additive attention module of claim 7, wherein the 2×2 down-sampler calculates the down-sampled copy of the input activation using average pooling.

9. A computing device, comprising:
a processor; and
a non-transitory computer-readable medium with instructions stored thereon, which when executed by the processor, perform steps comprising:
deploying a machine learning model having an input layer, a plurality of hidden layers, and an output layer;
down-sampling an input feature map of a first layer of the plurality of hidden layers to provide a basic adaptor input;
calculating a soft attention from the down-sampled input feature map;
binarizing the soft attention to obtain a set of binary weighting values selected from 0 and 1;
multiplying the basic adaptor input by the soft attention to provide a weighted basic adaptor input;
up-sampling the weighted basic adaptor input to provide a basic adaptor output;
adding the basic adaptor output to the input feature map to provide an adapted feature map;
multiplying the adapted feature map by the set of binary weighting values; and
providing the multiplied adapted feature map to a subsequent layer of the machine learning model.

10. The computing device of claim 9, wherein the computing device is an edge computing device.

11. The computing device of claim 9, wherein the computing device is a resource-limited processor.

12. The method of claim 9, wherein the soft attention is calculated using a Gumbel-softmax function.

13. The method of claim 9, wherein the binarization comprises a thresholding function.

14. The method of claim 9, wherein the instructions further comprise the step of freezing learned parameters of the machine learning model which have a multiplicative relationship with input activation.
